(19) United States
(12) Patent Application Publication
(10) Pub. No.: US 2007/0229955 A1
(43) Pub. Date: Oct. 4, 2007

(54) DIFFRACTION DEVICE

(75) Inventors: Yoshiji Kawamura, Tochigi (JP); Hajime Kurahashi, Tochigi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: FUJINON SANO CORPORATION, Sano-shi (JP)

(21) Appl. No.: 11/693,210

(22) Filed: Mar. 29, 2007

(30) Foreign Application Priority Data
Mar. 30, 2006 (JP) 2006-092707

(51) Int. Cl. G02B 5/18

(52) U.S. Cl. 359/569; 359/558

(57) ABSTRACT

A diffraction device having, on a transparent substrate plate, a diffraction pattern composed of periodically alternating array of first and second phase control zones. Each one of the first and second phase control zones is provided with an infinitesimal ruled structure in a pitch of the order of sub-wavelength, i.e., in a pitch smaller than the shortest wavelength of incident light, thereby to control phase shifts to the same angle in a plural number of wave ranges. The infinitesimal ruled structure in the first and second phase control zones are disposed in perpendicularly intersecting relation with each other. Thus, the diffraction device can diffract incident light with a diffraction efficiency free from dependency on wavelength and give a performance not dependent on the direction of polarization of incident light.

### BACKGROUND OF THE INVENTION

1. Field of the Art

This invention relates to a diffraction device useful for diffraction of incident light, and more particularly to a diffraction device which can give a performance barely dependent on wavelength.

2. Prior Art

Diffraction devices have been known and in use for diffraction of incident light. For example, diffraction device are used on optical pickups. In the case of an optical pickup, a light beam emitted from a light source is utilized not only as signal light but also as a focus error detection signal and a tracking error detection signal. Incident light is diffracted into a number of diffraction components including signal light of zero order and focus error detection signal light and tracking error detection signal light of ±1 orders. For this purpose, a diffraction device has a minutely ruled structure of the order of microns on a glass substrate plate.

Lately coming into wide use are optical pickups which are compatible with a mass storage disc format (an optical disc using a blue laser beam of 405 nm) in addition to CD format (Compact Disc using a laser beam of 780 nm) and DVD format (Digital Versatile Disc using a laser beam of 650 nm). Use of three separate optical pickups independently for the respective disc formats results in a pickup assembly which is objectionably large in size, so that attempts have been made to provide a multi-disc optical pickup by incorporating component parts which are compatible with the three wavelengths. In that case, it is necessary to employ a diffraction device which can cope with three different wavelengths.

In many cases, however, optical components to be used on an optical pickup are attuned to a specific wavelength. Diffraction devices used on optical pickups are not exceptions. Usually diffraction devices are attuned to have optimum diffraction efficiency at either CE, DVD or mass storage disc wavelength. Therefore, there has been a problem that a diffraction device which is attuned to one of CD, DVD and mass storage disc wavelengths can operate with a satisfactory diffraction efficiency at one wavelength but its diffraction efficiency is degraded at other wavelengths. Of course, a dip in diffraction efficiency at a certain wavelength gives rise to problems such as reduction of light power of that wavelength and deterioration of power distribution ratio between a diffraction component of zero order and diffraction components of ±1 orders, making it difficult to keep stable supply of signal light and supply of focus error detection signal and tracking error detection signal as well.

Attempts have been made to solve these problems, for example, in Japanese Laid-Open Patent Application H2005-141033. Namely, Japanese Laid-Open Patent Application H2005-141033 employs a periodic and alternating array of a double refractive optical anisotropic medium and an optical isotropic medium, causing a twist rotation to a primary axis of an index ellipsoid in a plane normal to or almost normal to a direction of an optical axis of light transmission of the optical anisotropic medium, about an axis parallel with the optical axis, making intensity modulation in each direction of polarization by rotating the direction of polarization.

Japanese Laid-Open Patent Application H2005-141033 resort to an optical anisotropic medium for rotating the direction of polarization in each one of grating zones. As for optical anisotropic medium, a polymeric liquid crystal is prepared by polymerization of low molecular weight liquid crystal of twist orientation. Thus, normally use a special polymeric liquid crystal has been required to get a diffraction efficiency free from dependency on wavelength. In an optical anisotropic medium, the direction of polarization is rotated by the use of a polymeric liquid crystal, a product of polymerization of low molecular weight liquid crystal of twist orientation. That is to say, the orientation of optical anisotropy needs to be adjusted by way of pre-twist and twist angles, and this gives rise to a necessity for fine adjustments of the angle of the grooves which are filled with the optical anisotropic medium. Further, control of the rotating angle of the direction of polarization by an optical anisotropic medium requires various adjustments such as adjustments of pre-twist angel, twist angle, properties of the polymeric liquid crystal and height of gratings.

Thus, in case a special polymeric liquid crystal, which is obtained by polymerization of low molecular weight liquid crystal, is used for rotating a direction of polarization, various fine adjustments become necessary as mentioned above. Especially in the case of an optical pickup which deals with waves of the order of nanometers, extremely strict adjustments are required for various factors as mentioned above. That is to say, if the adjustments of various factors are imperfect, it becomes difficult to attain an aimed diffraction efficiency free of irregular variations. On the contrary, strictness is pursued thoroughly in various adjustments, it makes the fabrication of the diffraction device difficult, giving rise to a serious problem such as a huge production cost.

### SUMMARY OF THE INVENTION

It is an object of the present invention to provide a diffraction device with a diffraction efficiency barely dependent on wavelength, without using a special or extraordinary liquid crystal.

According to the present invention, there is provided a diffraction device, which comprises: a diffraction pattern formed on a transparent substrate plate and composed of an periodically alternating array of first and second phase control zones; each one of the first and second phase control zones having an infinitesimal ruled structure in a pitch of the order of sub-wavelength thereby to control phase shifts to the same angle in a plural number of wave ranges of incident light; and the infinitesimal ruled structures in the first and second phase control zones being disposed in perpendicularly intersecting relation with each other.

By adoption of the construction as described above, it becomes possible to realize a diffraction device which can give a satisfactory diffraction efficiency free from dependency on wavelength and free from the direction of polarization of incident light.

### BRIEF DESCRIPTION OF THE DRAWINGS

In the accompanying drawings:

FIG. 1 is a schematic plan view of a diffraction device;

FIG. 2 is a schematic side view of the diffraction device;

FIG. 3 is an enlarged fragmentary view of the diffraction device;

FIG. 4 is a characteristics diagram plotting effective refractivity against a wavelength to pitch ratio;

FIG. 5 is a schematic illustration explanatory of diffractive actions in relation with a direction of polarization of incident light;

FIG. 6 is a schematic plan view of a diffraction device having infinitesimally minute ruled structures in first and second phase control zones formed in an oblique pattern;

FIG. 7 is a characteristics diagram plotting phase shift against wavelength;

FIG. 8 is a characteristics diagram plotting diffraction efficiency against wavelength; and

FIG. 9 is a schematic plan view of a diffraction device having first and second phase control zones in the form of concentric orbicular zones.

### DESCRIPTION OF PREFERRED EMBODIMENTS

A. Construction of Diffraction Device

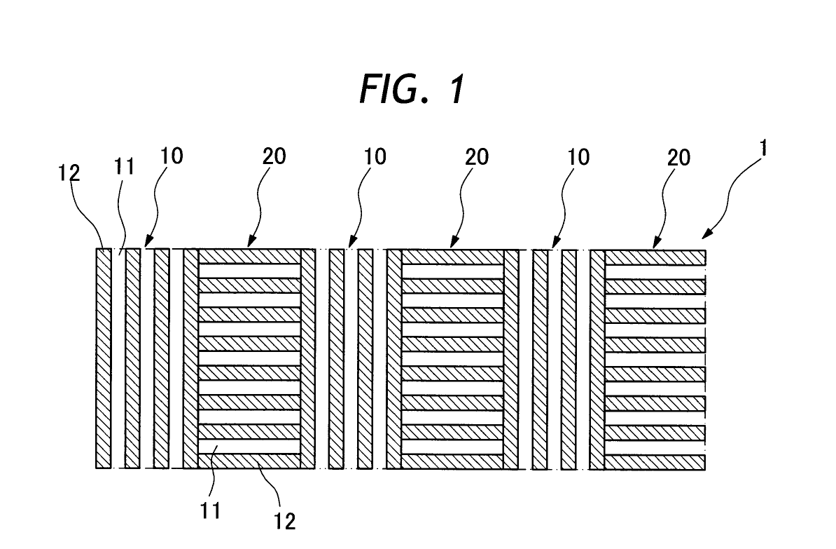

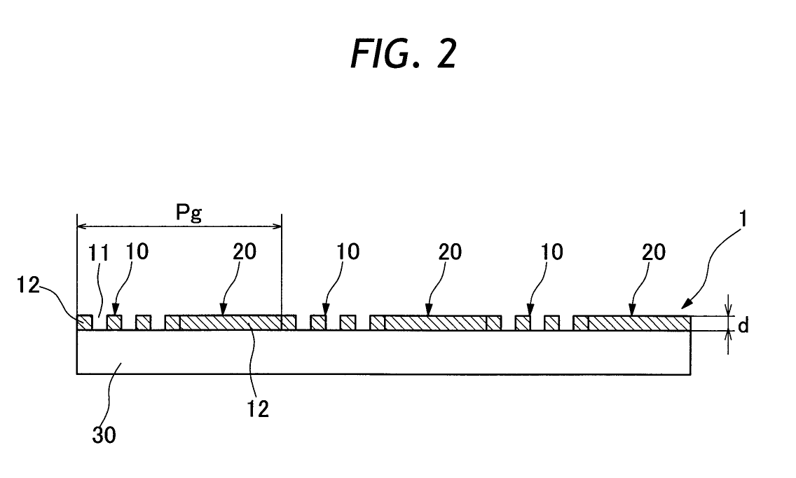

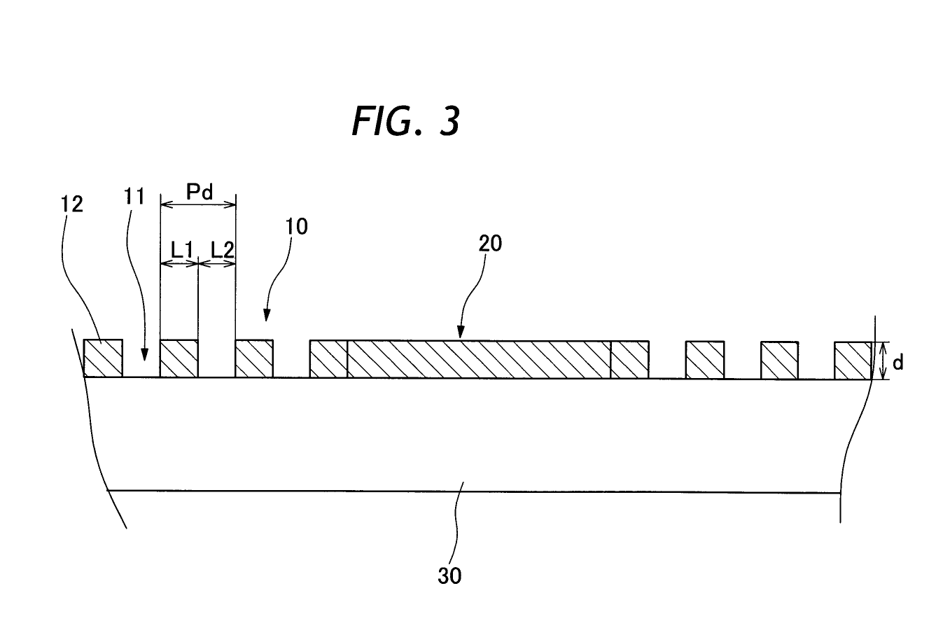

Now, the present invention is described more particularly by way of its preferred embodiments with reference to the accompanying drawings. Shown in FIGS. 1 and 2 is a diffraction device 1 according to the invention, the diffraction device 1 having an array of first phase control zones 10 and second phase control zones 20 formed on a transparent substrate plate 30 like a glass plate. As shown in FIG. 1, the diffraction device 1 is of a periodic structure having the first phase control zones 10 and the second phase control zones 20 periodically in alternate positions. As shown also in FIG. 3, each one of the first and second phase control zones 10 and 20 has a ruled surface structure of an infinitesimally small pitch. The ruled structure of an infinitesimal pitch is formed by transferring low and high surface profiles to a plastic or synthetic resin material or by engraving grooves on a surface of the transparent substrate plate 30 itself. The low surface portions of the ruled surface structure (hereinafter referred to as “grooves 11”) are air layers, while the high surface portions are medium layers of synthetic resin or glass material (hereinafter referred to as “medium layers 12”). Thus, there is a difference in refractivity between a low surface portion or groove 11 which is an air layer and a high surface portion or medium layer 12. Namely, a low surface portion 11 is lower in refractivity than a high surface portion 12. That is to say, the propagation velocity becomes higher in low surface portions 11 than in high surface portions 12.

The ruled structures of the first phase control zones 10 are disposed perpendicularly and alternately relative to the ruled structures of the second phase control zone 20. Each one of the first and second phase control zones 10 and 20 is constituted by an infinitesimally minute ruled structure formed in an infinitesimal pitch or in sub-wavelength periods of the order of nanometers. On the other hand, the alternating pattern of the first and second phase control zones 10 and 20 is a periodic pattern of the order of microns. Thus, the diffraction device 1 is made up of two patterns: (1) an infinitesimal pitch pattern formed by the infinitesimal ruled structure in each one of the first and second phase control zones 10 and 20; and (2) an alternating pattern of the first and second phase control areas 10 and 20. Of the two patterns (1) and (2) just mentioned, the pattern (1) is intended for a function of adjusting the phase of a wave to be used (at a target wavelength in incident light on the diffraction device 1), while the pattern (2) is intended for a diffractive function. By the combination of the functions (1) and (2), the diffraction device 1 can function as a diffraction device with a diffraction efficiency barely dependent on wavelength, as described in greater detail below.

As mentioned hereinbefore, ruled structures of an infinitesimal pitch (hereinafter referred to as “infinitesimal pitch Pd”) are provided in the alternating first and second phase control zones 10 and 20 in perpendicularly intersecting directions. In this instance, the infinitesimal ruled structures of the first and second phase control areas 10 and 20 are formed in an infinitesimal pitch Pd which is smaller than the shortest wavelength of incident light to be diffracted by the diffraction device 1 (hereinafter referred to as “a pitch smaller than the shortest wavelengh”). In order to let the infinitesimal ruled structures of the first and second phase control areas 10 and 20 have a function of matching the phases of target waves, it is necessary to prevent occurrence of isolated or discrete diffractive phenomena to these waves. Here, the infinitesimal pitch Pd can be expressed by an equation “Pd×singθ=m×λ” where λ is the wavelength of incident light and θ is the diffraction angle of light of m order. In order to prevent the occurrence of the above-mentioned diffractive phenomena, the infinitesimal pitch Pd should satisfy the condition of “Pd<λ.” Thus, the infinitesimal pitch Pd must be smaller than the shortest wavelength of incident light.

As shown in FIG. 2, with the infinitesimal pitch Pd, a periodic pair of the first and second phase control areas 10 and 20 which occurs at an interval Pg (hereinafter referred to as “a diffraction pitch Pg”) is in the relation of “Pg>Pd.” The diffraction pitch Pg is in the relation of Pg>Pd because each one of the first and second phase control zones 10 and 20 is constituted by a series of minute up-and-down surface profiles in an infinitesimal pitch.

The infinitesimal pitch Pd is expressed as “Pd=L1+L2” where L1 and L2 are widths of a medium layer 12 and a groove 11, respectively, and the same infinitesimal pitch Pd is applied to infinitesimal ruled structure in both of the first and second phase control zones 10 and 20. Of course, the infinitesimal pitch Pd of the first phase control zone 10 is not necessarily required to be same as the infinitesimal pitch Pd of the second phase control zone 20 provided that both of the applied infinitesimal pitches are smaller than the shortest wavelength in the wave range of incident light. Further, the widths L1 and L2 of the medium layer 12 and groove 11 may not be of the same measure. That is, there is no necessity for halving the filling factor of the medium layer 12 (and groove 11) relative to the infinitesimal pitch Pd.

In this instance, when light is shed on the first phase control zone 10 with the infinitesimal ruled structure of the order of sub-wavelength, it functions to match phase shifts of incident waves. Namely, the infinitesimal ruled structure has a difference in effective refractivity between a periodic direction and a non-periodic direction. That is to say, the refractivity varies depending upon the direction of polarization of incident light, giving the effects of double refraction on incident light. Under the effect of double refraction, the propagation velocity of light becomes lower at a position where the index of refractivity is greater and higher at a position where the index of refractivity is smaller.

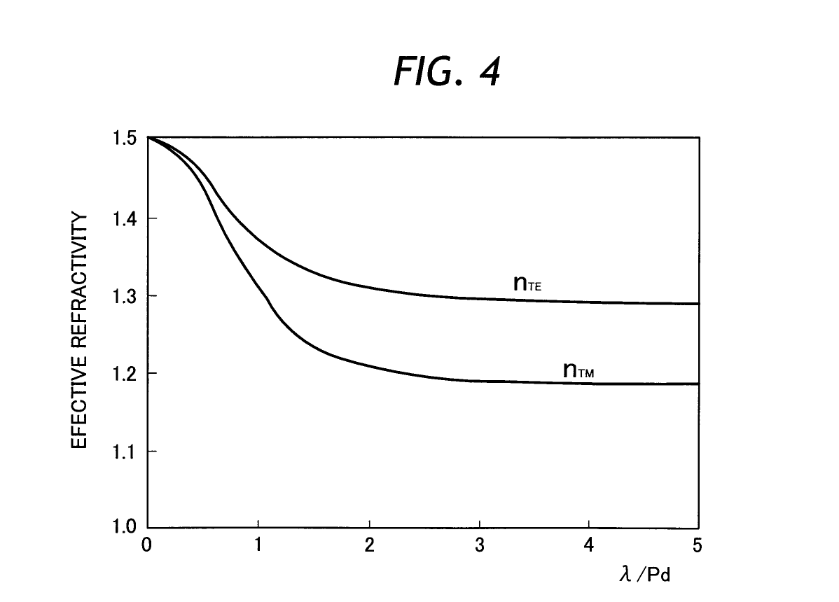

At this time, a light ray incident on an infinitesimal ruled structure of the order of sub-wavelength undergoes a phase shift R, which can be expressed by “R=(n_{TE}−n_{TM})×d/λ” where n_{TE} is an index of refraction for light polarized in a direction parallel with the infinitesimal ruled structure, n_{TM} is an index of refraction for light polarized in a direction vertical to the infinitesimal ruled structure, d is the height of the medium layers and λ is the wavelength of incident light. Shown in the graph of FIG. 4 are the relations between the phase shift R and a ratio of the wavelength of incident light to the infinitesimal pitch Pd (λ/Pd). In FIG. 4, a figure “1” on the axis of abscissa (λ/Pd) indicates a position where the wavelength λ is equal to the infinitesimal pitch Pd. At around “λ/Pd=1”, the difference between the indices of refraction n_{TE} and n_{TM} becomes greater with increases in wavelength λ. The difference between the indices of refraction n_{TE} and n_{TM} is part of the numerator in the above equation. On the other hand, the wavelength λ is the denominator in the above equation. Therefore, the longer the wavelength λ, the larger becomes the difference between the indices of refraction n_{TE} and n_{TM}. That is to say, the greater the denominator in the above equation, the larger becomes the numerator. Thus, the phase shift R becomes almost constant when the value of “λ/Pd” on the axis of abscissa is around “1.” This means that the phase shift R becomes constant, irrespective of the wavelength λ.

Especially, as clear from the same figure, when the value of “λ/Pd” on the axis of abscissa is approximately between 1.0 and 2.0, inclusive, the curve of the refraction index n_{TE} draws a gentle curve in contrast to the refraction index n_{TM} which draws a steep curve. Namely, in a range where the infinitesimal pitch Pd is “1.0” to “0.5” times as large as the wavelength λ of incident light, the difference in refractivity becomes greater at longer wavelengths. Thus, the phase shift R becomes constant in that range.

In this instance, the phase shift R varies depending upon the height of the medium layers 12. The indices of refraction n_{TE} and n_{TM} are determined by the refractivity of the medium layers 12 and refractivity and filling factor of the grooves or air layers 11. As mentioned hereinbefore, the filling factor is an occupancy rate of the width L1 of the medium layer 12 in an infinitesimal pitch Pd, i.e., “L1/Pd.” Thus, the phase shift R can be determined by way of various elements such as the infinitesimal pitch Pd, height d of the medium layers 12, selection of an index of refractivity, filling factor and so forth. In the case of the present embodiment, it suffices for the diffraction device 1 to be capable of matching the phase shift R of target waves incident on the diffraction device 1, and suitable values are set for the just-mentioned elements to this effect, that is, for matching the phase shift R of target waves. For example, in the case of an optical pickup which is required to cope with three disc formats, i.e., mass storage disc, DVD and CD formats, there are three target waves of 405 nm, 650 nm and 780 nm. Thus, values of the above-mentioned elements are determined in such a way as to match the phase shift R in each one of the three target ranges, namely, in such a way as to match the phase shift R in a plural number of target wave ranges.

The infinitesimal structures in the second phase control zones 20 also function to match the phase shift R and constructed in the same manner as the infinitesimal ruled structures of the first phase control zones 10. However, the infinitesimal ruled structures of the second phase control zones 20 are disposed in perpendicularly intersecting relation with the counterparts of the first phase control zones 10, so that they have an inversed refractive action relative to the direction of polarization of incident light.

As mentioned above, the first and second phase control zones 10 and 20 are so arranged as to have functions of matching the phase shift R in a plural number of wave range (a plural number of target wave ranges). The use of the diffractive pattern having the fist and second phase control zones 10 and 20 periodically in alternate positions can realize a diffraction device 1 which has a diffraction efficiency barely dependent on wavelength. The reason why is explained below.

The infinitesimal ruled structures in the first and second phase control zones 10 and 20 are disposed in perpendicularly to each other, and therefore have different indices of refraction relative to the direction of polarization of incident light. Further, a plural number of first and second phase control zones 10 and 20 each with ab infinitesimal ruled structure of the order of sub-wavelength are arrayed to form a diffractive pattern. In this diffractive pattern having the first and second phase control zones 10 and 20 periodically in alternating positions, a diffractive phenomenon is caused by the difference in index of refractivity between the first and second phase control zones 10 and 20. Namely, the alternating pattern of the first and second phase control zones 10 and 20 can be regarded as being same as grooved diffraction elements in general, and, by the occurrence of a phenomenon of diffraction, has diffractive effects on incident light. In order to have this function, the diffraction elements in general need to have un and down diffracting surfaces. In contrast, in the case of the diffraction device 1 according to the invention, there is no need for locating the first and second phase control zones 10 and 20 at upper and lower levels. That is to say, the array of the alternating first and second phase control zones 10 and 20 can play the same role as the grooved diffraction devices in general.

The first and second phase control zones 10 and 20 have a diffraction pitch defined by a plural number of gratings formed in the order of nanometers, while the first and second phase control zones 10 and 20 themselves are formed in a pitch in the order of microns although not necessarily limited to the order of microns. In order to have a diffractive action, at least the diffraction pitch Pg must be higher than the wavelength λ of incident light. For the occurrence of a phenomenon of diffraction, it is a must to satisfy the condition of “Pg≧λ”. As long as this condition is satisfied, an arbitrary diffraction pitch Pg may be adopted. Further, although the first and second phase control zones 10 and 20 are formed in the same width in the particularly embodiment shown, they may be formed in different widths if desired.

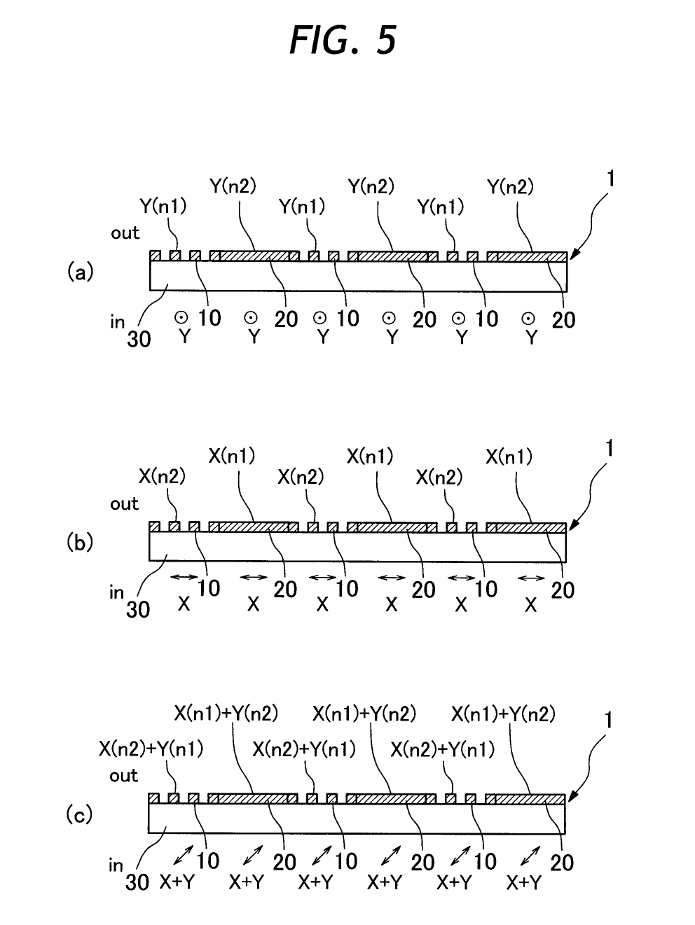

Now, a diffractive action of the diffraction pattern is explained more particularly with reference to FIG. 5. In FIG. 5, incident light enters the diffraction device 1 from the side labeled with “in” and leaves on the side labeled with “out.” In FIG. 5(a), incident light on the diffraction device 1 is polarized light (hereinafter referred to as “Y-polarized light”) which has a direction of polarization parallel with the infinitesimal ruled structures in the first phase control zones 10. At this time, the direction of polarization of incident light is parallel with the infinitesimal ruled structure of the first phase control zone 10 but is in perpendicularly intersecting relation with the infinitesimal ruled structures of the second phase control zone 20. In this instance, the relationship of “n1>n2” can be established, where n1 is an index of refraction of polarization light parallel with the infinitesimal ruled structure (an index of refraction of incident light polarized in a direction parallel with the infinitesimal ruled structure) and n2 is an index of refraction of perpendicular polarization light (an index of refraction of incident light polarized in a direction perpendicular to the infinitesimal ruled structure). That is to say, there is a difference in refractivity between the first and second phase control zones 10 and 20. Thus, diffraction occur to light rays incident on the diffraction device 1.

In this instance, as mentioned above, there can be established a formula of “Pg×sin θ=m×λ” where θ is the diffraction angle of a diffraction component of order m. The diffraction angle θ for diffraction components of orders ±1 is given by an equation “θ=sin⁻¹⁽λ/Pg). Thus, the diffraction components of orders ±1 which are used as focus error signals and tracking error signals can be determined arbitrarily by way of the wavelength and diffraction pitch Pg to be used. Normally, the diffraction pitch Pg is set in the range of from several microns to several hundreds microns to produce diffraction effects.

Further, energy distribution ratio of the diffraction component of order zero to the diffraction components of orders ±1 is determined by a phase difference between a light ray which is transmitted through the first phase control zones 10 and a light ray which is transmitted through the second phase control zones 20. At this time, the phase difference itself is determined by the height d of the medium layers 12. That is to say, the energy distribution ratio can be controlled arbitrarily through control of the height d of the medium layers 12.

Now, shown in FIG. 5(b) is a case where a polarized light beam which is polarized in a direction parallel with the infinitesimal ruled structures of the second phase control zones 20 (hereinafter referred to as “X-polarized light” is incident on the diffraction device 1. In this case, the direction of polarization of incident light is parallel with second phase control zones 20 but perpendicular to the first phase control zones 10. Therefore, the index of refraction of light which is transmitted through the first phase control zones 10 is higher as compared with that of light which is transmitted through the second phase control zones 20. That is to say, there is a difference in refractivity between the first and second phase control zones 10 and 20, and the diffraction device 1 has diffracting effects on incident light.

Shown in FIG. 5(c) is a case of an incident light beam which is inclined relative to infinitesimal ruled structures of both first and second phase control zones 10 and 20. Namely, an incident polarized light beam is inclined relative to both X- and Y-polarizations. In this case, the two polarization components in the incident light beam, i.e., X- and Y-polarized components, can be separated from each other. This is because the first phase control zones 10 have a lower index of refraction (n1) for Y-polarization light and have a higher index of refraction (n2) for X-polarization light. On the other hand, the second phase control zones 20 have a lower index of refraction (n1) for X-polarization light and have a higher index of refraction (n2) for Y-polarization components Accordingly, the different refractive actions on the X- and Y-polarization components cause a difference in propagation velocity between the X- and Y-polarization components, thus producing a diffractive effect as a whole.

Irrespective of the direction of polarization of incident light, the diffraction device 1 can produce a diffractive effect. In other words, the diffraction device 1 is operative free of dependency on the direction of polarization.

As explained above, the diffraction device according to the present invention functions to match phase shifts in a plural number of wave ranges by the use of an infinitesimal ruled structure of the order of sub-wavelength formed in each one of the first and second phase control zones, while performing a function as a diffraction element by means of the periodically alternating array of the first and second phase control zones which have the infinitesimal ruled structures in perpendicularly intersecting relations with each other. As a consequence, a diffraction device with a diffraction efficiency free from dependency on wavelength can be realized without using special liquid crystals. Besides, polarized components of incident light can be separated by the infinitesimal ruled structures of the first and second phase control zones 10 and 20, which are disposed perpendicularly to each other, realizing a diffraction device which can give performances free from dependency on the direction of polarization of incident light.

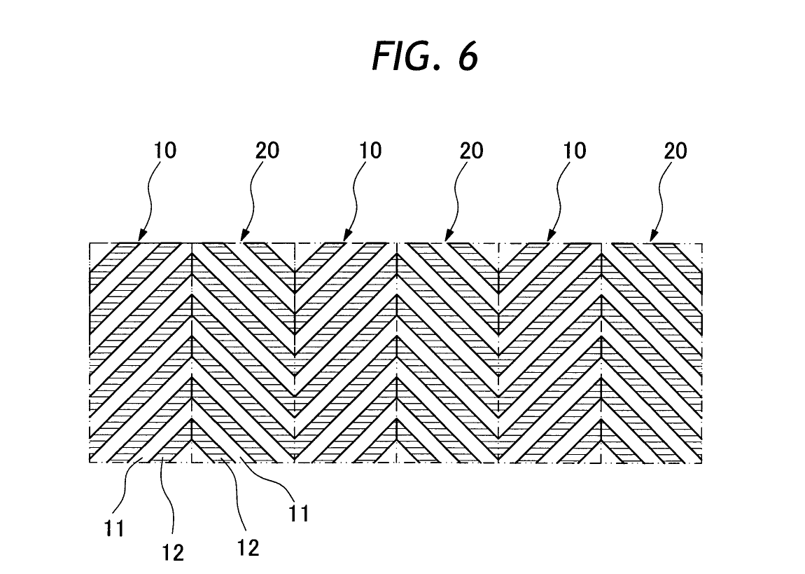

In the case of the embodiment shown in FIG. 1, infinitesimal ruled structures of the first phase control zones 10 are formed crosswise of the rectangular transparent substrate plate 30, while equivalent infinitesimal ruled structures of the second phase control zones 20 are formed in the longitudinal direction of the substrate plate 30. However, as shown in FIG. 6, the medium layers of the infinitesimal ruled structures may be formed obliquely relative to the crosswise and longitudinal directions of the transparent substrate plate 30, in the fashion of a chevron, provided that the up-and-down surface structures of the first and second phase control zones 10 and 20 are disposed perpendicularly to each other.

B. Diffraction Efficiency of Diffraction Device 1

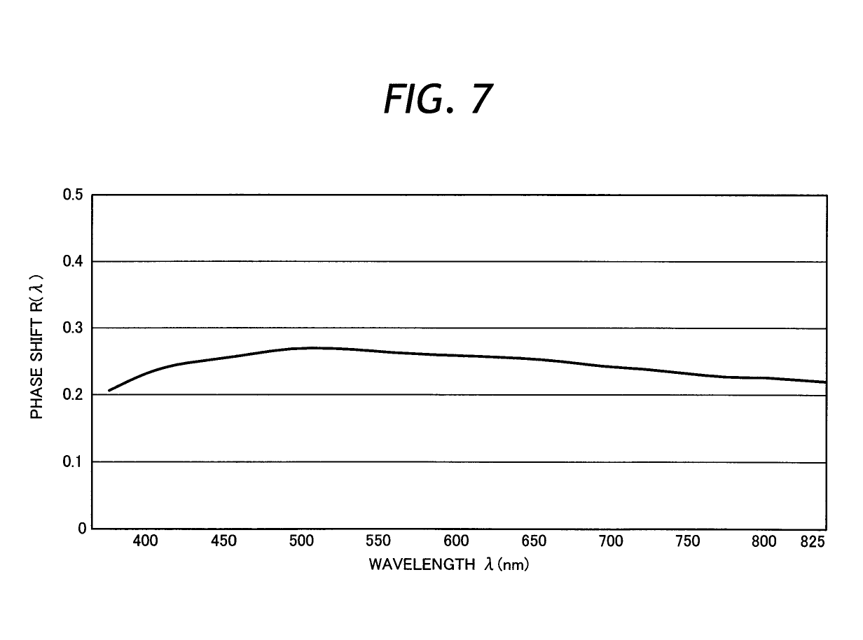

The above-described diffraction device 1 has following characteristics in diffraction efficiency. Plotted in FIG. 7 are phase shifts by the first and second phase control zones 10 and 20 in various wave ranges. In this particular case, the infinitesimal pitch Pd of the infinitesimal ruled structures in the first and second phase control zones 10 and 20 is “400 nm,” the width L2 of the grooves 11 is “125 nm” and the width L1 of the medium layers 12 is “275 nm.” Target wavelengths are a number of different wave ranges including three wave ranges of CD format (780 nm), DVD format (650 nm) and blue laser mass storage disc format (405 nm). In this particular case, the target wavelengths approximately range from 395 nm to 815 nm. The height d of the grating is “2400 nm.” Needless to say, the target wave range is not necessarily limited to the wave range of from 395 nm to 815 nm mentioned above. Strictly speaking, the wavelengths of the blue laser mass storage disc, DVD and CD formats are not always 405 nm, 650 nm and 780 nm, respectively. These rated wavelengths are median wavelengths and can vary to some extent. In the case of CD, there are two formats having median wavelengths at 785 nm and 790 nm, respectively. Since the wavelength can vary by 25 nm from the median wavelengths 785 nm and 790 nm, the wave range for the CD format covers a range approximately “from 760 nm to 815 nm.” The wave range for the DVD format has a median wavelength at 660 nm and can vary by 20 nm from that median wavelength. Thus, the wave range for the DVD format covers a range approximately “from 640 nm to 680 nm.” The wave range for the blue laser mass storage disc has a median wavelength at either 405 nm or 408 nm. Therefore, considering variations of 10 nm or 8 nm from the median wavelengths 405 nm and 408 nm, the wave range for the blue laser mass storage disc covers a range approximately “from 395 nm to 415 nm.”

In this instance, the infinitesimal pitch Pd of the infinitesimal ruled surface structures in the first and second phase control zones 10 and 20 is “400 nm,” which is shorter than the shortest wavelength “405 nm” of incident light. Thus, the infinitesimal pitch Pd satisfies the condition that it must be smaller than the shortest wavelength. As seen in FIG. 7, by the infinitesimal ruled structures of the order of sub-wavelength which are formed periodically in the first and second phase control zones 10 and 20, the phase shift is controlled to a value close to “0.25” at each one of the three wavelengths, i.e., the blue laser mass storage disc wavelength of 405 nm, DVD wavelength of 650 nm and CD wavelength of 780 nm. Since phase angle of one wave is “360°,” the phase difference “0.25” means “90°” Thus, phase differences can be controlled approximately to “90°” in all wave ranges.

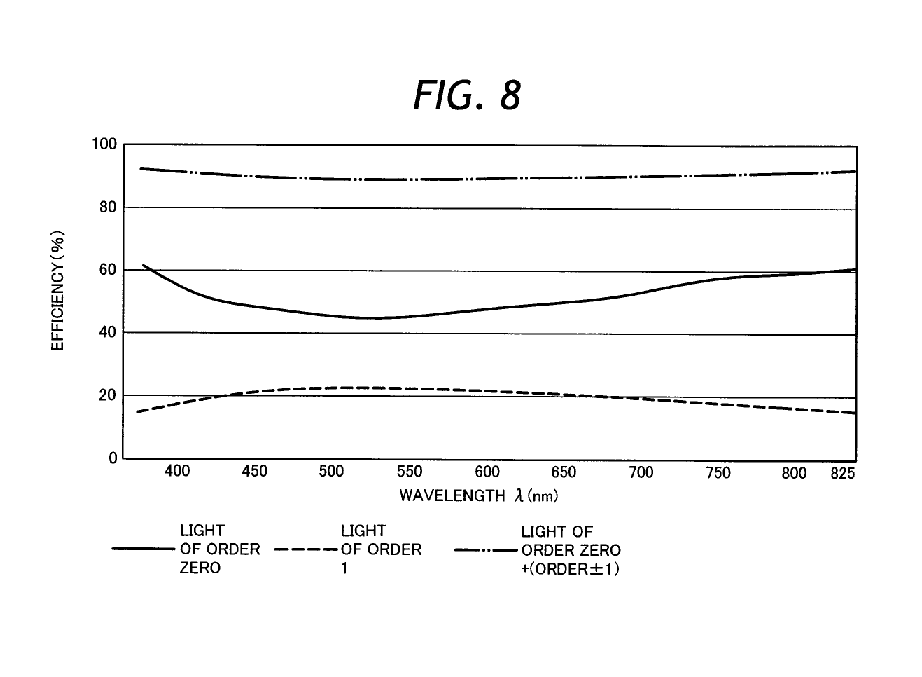

The orthogonal arrangement of the infinitesimal ruled surface structures in the first phase control zones 10 relative to the counterparts in second phase control zones 20 makes a difference in refractivity between the firs and second phase control zones 10 and 20 15 in relation with the direction of polarization of incident light. That is to say, a diffraction phenomenon occurs to incident light. As mentioned above, by the first and second phase control zones 10 and 20, phase shifts are controlled close to “90°” in all wave ranges of 405 nm, 650 nm and 780 nm, the diffraction device has an almost constant diffraction efficiency in all of the wave ranges of blue laser mass storage disc, DVD and CD as shown in FIG. 8. As seen in that figure, with regard to the sum of diffraction components of zero order and orders ±1, a diffraction efficiency of approximately 90% is obtained almost flatly irrespective of wavelengths. As clear from the same figure, for a diffraction component of zero order, a diffraction efficiency of approximately 50% is obtained flatly in each wave range. For diffraction components of orders ±1, a diffraction efficiency of approximately 20% is obtained in each wave range.

Thus, a stable diffraction efficiency free from dependency on wavelength can be obtained not only for the diffraction component of zero order to be used as signal light but also for the diffraction components of orders ±1 to be used as focus error detection signal and tracking error detection signal. That is to say, it becomes possible to supply signal light as well as a focus error detection signal and a tracking error detection signal in a stabilized state in all wave ranges, realizing a diffraction device with diffraction efficiency free from dependency on wavelength.

Phases shifts can be brought to the same angle in each one of target wave ranges (405 nm, 650 nm & 780 nm) by selecting and determining optimum values for the infinitesimal pitch Pd and the height d and filling factor of the medium layers 12 in relation with the target waves to be used. In that case, there can be obtained a diffraction device 1 with a diffraction efficiency completely free from dependency on wavelength. Of course, even if being unable to bring the phase shifts perfectly to the same angle in the respective target wave ranges, the first and second phase control zones 10 and 20 act to uniformalize phase shifts in target wave ranges, permitting to select suitable settings for the above-mentioned factors and elements.

In the foregoing description, the diffraction device 1 has been described in relation with the three wavelengths of 405 nm, 650 nm and 780 nm, i.e., three wave ranges for the blue laser mass storage disc, DVD and CD formats. Of course, application of the diffraction device 1 is not limited to three wave ranges, and can be adapted to cope with two wave ranges. For example, in the case of a diffraction device to be applied to two wave ranges of CD and DVD formats, a diffraction efficiency free from dependency on wavelength can be obtained by setting the infinitesimal pitch Pd at a value smaller than the shortest wavelength 650 nm.

Further, as mentioned above, there are two kinds of blue laser mass storage disc formats, one having a median wavelength at 405 nm and the other one at 408 nm, with a variation of approximately 10 nm from the median wavelength in the former format and a variation of approximately 8 nm in the latter format. Therefore, presumably the shortest wavelength is 395 nm. That is to say, the infinitesimal pitch Pd must be smaller than 395 nm in the case of a mass storage disc using a blue laser of 395 nm. In a case where the value of the infinitesimal pitch Pd is set 394 nm, for example, an adequate diffraction efficiency can be obtained by setting the width L2 of the grooves 11 at 123 nm and the width L1 of the medium layers 12 at 271 nm.

C. Method for Fabricating the Diffraction Device

The above-described diffraction device 1 can be fabricated by a method as described below. The infinitesimal ruled structures of the first and second phase control zones 10 and 20 are periodic structures of the order of sub-wavelength. That is to say, it is necessary to form minute ruled structures of the order of nanometers, requiring to form the medium layers and grooves in an infinitesimal pitch. The infinitesimal ruled structures can be formed, for example, by etching or by vapor deposition. Described below is a method of fabricating the diffraction device 1 by a nano-imprinting method which is high in productivity as a micro-structure patterning method.

Namely, nano-imprinting is a method of transferring a pattern of infinitesimally minute structures by the use of a mold. In this regard, two different nano-imprinting methods are available, one is a thermal nano-imprinting method and the other one is a photo-setting nano-printing method. In the case of the thermal nano-imprinting, a pattern is transferred by the use of a thermoplastic synthetic resin material. On the other hand, in the photo-setting, a pattern is transferred by the use of a UV (Ultraviolet) setting synthetic resin material. Described below by way of example is a thermal nano-printing method which permits a wide selection of synthetic resin materials for use in thermal nano-printing.

In the case of thermal nano-imprinting, a thermoplastic synthetic resin material is coated on a transparent glass substrate, and a mold with a pattern of infinitesimally minute structures is pressed with heating to imprint the minute structures onto the synthetic resin material. After imprinting the pattern, the mold is cooled down and separated from the thermoplastic resin. By this imprinting operation, a pattern of minute structures on the part of the mold is transferred onto the resin material. Thus, firstly it is necessary to prepare an imprinting mold with a pattern of the diffraction device 1, i.e., a pattern having alternately and periodically the first and second phase control zones 10 and 20 with the infinitesimal ruled structures in perpendicularly intersecting relation with each other. The pattern of the diffraction device 1 prepared on the imprinting mold is then transferred onto a thermoplastic resin material which is coated on a transparent substrate plate. In this manner, the diffraction device 1 can be fabricated by nano-imprinting.

Instead of the above-described thermal nano-imprinting, the diffraction device 1 may be fabricated by a photo-setting nano-imprinting process. Alternatively, it may be fabricated by an etching or vapor deposition process. Any other arbitrary method may be employed as long as the a pattern of the infinitesimally minute structures of the diffraction device 1 can be formed.

E. Another Shape of the Diffraction Device

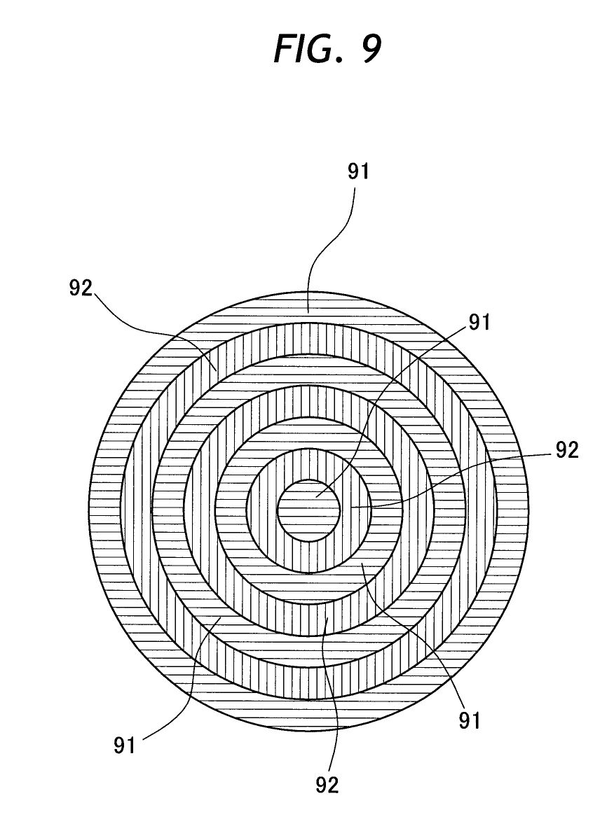

Shown in FIG. 9 is a diffraction device of a different shape as compared with the ones shown in FIGS. 1 and 6. In the case of the diffraction device of FIG. 9, the first and second phase control zones are arranged in the form of concentric orbicular zones. Namely, the diffraction device have the first and second phase control zones 91 and 92 periodically in alternate positions like the diffraction devices of FIGS. 1 and 6. However, in contrast to the diffraction devices of FIGS. 1 and 6 having the first and second phase control zones 10 and 20 alternately in a rectilinear direction, the diffraction device of FIG. 9 has first and second phase control zones 91 and 92 arranged as concentric orbicular zones. Although different from the embodiments of FIGS. 1 and 6 in shape, the alternating first and second phase control zones 91 and 92 have the respective infinitesimal ruled structures disposed perpendicularly to each other.

Thus, the diffraction device functions to control phase shifts to the same angle in a plural number of wave range by means of the infinitesimal ruled structure having medium layers and grooves in a pitch in the order of sub-wavelength and formed in each one of the alternating first and second phase control zones 91 and 92, while diffracting incident light free from dependency on wavelength by means of the alternating array of the first and second phase control zones 91 and 92 which have the infinitesimal ruled structures in perpendicularly intersecting relation with each other.

What is claimed is:

1. A diffraction device, comprising:
a diffraction pattern formed on a transparent substrate plate and composed of an periodically alternating array of first and second phase control zones;
each one of said first and second phase control zones having an infinitesimal ruled structure in a pitch of the order of sub-wavelength thereby to control phase shifts to the same angle in a plural number of wave ranges of incident light; and
said infinitesimal ruled structures in said first and second phase control zones being disposed in perpendicularly intersecting relation with each other.

2. A diffraction device as defined in claim 1, wherein said incident light includes light beams of at least two different wave ranges, selected from a light beam in a wave range of from 395 nm to 415 nm, a light beam in a wave range of from 640 nm to 680 nm and a light beam in a wave range of from 760 nm to 815 nm.

3. A diffraction device as defined in claim 1, wherein infinitesimal ruled structures in said first and second phase control zones are arranged obliquely relative to transverse and longitudinal directions of said transparent substrate plate.

4. A diffraction device as defined in claim 1, wherein said diffraction pattern is in the form of concentric orbicular zones alternately occupied by said first and second phase control zones.
